(19) United States
(12) Patent Application Publication
(10) Pub. No.: US 2019/0092367 A1
(43) Pub. Date: Mar. 28, 2019

(54) HANDLE HEATER

(71) Applicant: SWCC SHOWA CABLE SYSTEMS CO., LTD., Kanagawa (JP)

(72) Inventor: Masahiro MORI, Tokyo (JP)

(21) Appl. No.: 16/083,013

(22) PCT Filed: Feb. 28, 2017
(86) PCT No.: PCT/JP2017/007591

§ 371 Date: Sep. 7, 2018

(30) Foreign Application Priority Data
Mar. 7, 2016 (JP) 2016-043468

(51) Int. Cl. B62D 1/06; H05B 3/02; H05B 3/03; H05B 3/20; H05B 3/34

(52) U.S. Cl. CPC B62D 1/065; H05B 3/02; H05B 3/34; H05B 3/20; H05B 3/03

(57) ABSTRACT

This handle heater comprises a mesh heating body comprising a plurality of heater wire strands woven into mesh, and electrodes disposed at both ends of the mesh heating body. Each of the electrodes comprises a metal foil whereon the mesh heating body is welded, and an insulating protective tape sandwiching, by being folded back along the width direction of the mesh heating body, the front and back surfaces of an electrode base body containing the metal foil and one of the ends of the mesh heating body. The mesh heating body is disposed in such a manner that each end in the length direction thereof follows an edge surface of the corresponding metal foil, and a space is present between the length direction end of the electrode base body and the folded-back portion of the protective tape.

### TECHNICAL FIELD

The present invention relates to a technique useful for a handle heater.

### BACKGROUND ART

Traditionally, handle heaters for warming a steering wheel have been practically applied in automobiles used in cold districts (see, e.g., Patent Literatures (hereinafter, referred to as “PTLs”) 1 to 3). The steering wheel is quickly heated by such a handle heater when driving is started, so that a driver can drive comfortably.

FIGS. 1 and 2 illustrate a traditional handle heater. FIG. 1 is a plan view illustrating heater main body 20 of the handle heater, and FIG. 2 is a sectional view illustrating an end (electrode portion) of heater main body 20. As illustrated in FIGS. 1 and 2, heater main body 20 includes mesh heating element 21 including heater wires (whose reference numeral is omitted) knitted into mesh. Mesh heating element 21 is formed into a belt shape as a whole. Electrodes 22A and 22B are disposed to the both ends of mesh heating element 21 along warp direction V in which loops of mesh heating element 21 are formed. The both edges of mesh heating element 21 along warp direction V are hemstitched by threads in order to prevent deformation of the mesh shape of mesh heating element 21.

Heater main body 20 is attached to steering-wheel main body 30 as handle heater 2 such that heater main body 20 is tightly fitted to a cover made, for example, from leather or resin (see FIG. 3). Specifically, handle heater 2 is attached to steering-wheel main body 30 by sewing together the edges of the cover along warp direction V while positioning heater main body 20 inside the cover and along a rim portion (annular portion to be held during driving) of steering-wheel main body 30. Moreover, the ends of handle heater 2 in the length direction are brought to closely face each other and sewn together. Accordingly, the electrode portions disposed to the both ends of heater main body 20 in the length direction approach each other.

Here, electrodes 22A and 22B each have a structure in which a corresponding one of the ends of mesh heating element 21 is placed on metal foil 221 and welded thereto such that the end of mesh heating element 21 and metal foil 221 are planar and thin, and the end of mesh heating element 21 and metal foil 221 are sandwiched by protective tape 222 made of an insulating material. Specifically, electrode base 23 including metal foil 221 and mesh heating element 21 welded together is disposed on protective tape 222 and protective tape 222 is folded back along electrode base 23, so that the front and back sides of electrode base 23 is protected. Thus, at each of electrodes 22A and 22B, the end of electrode base 23 is in contact with the folded-back portion of protective tape 222.

### CITATION LIST

### Patent Literature

### PTL 1

### Japanese Patent Application Laid-Open No. 2003-123947

### PTL 2

### Japanese Patent Application Laid-Open No. 2008-114680

### PTL 3

### Japanese Patent Application Laid-Open No. 2007-134083

### SUMMARY OF INVENTION

### Technical Problem

Normally, in each electrode base 23, mesh heating element 21 is cut such that an end of mesh heating element 21 is aligned with an end surface of metal foil 221. For this reason, in traditional heater main body 20 as mentioned above, there may be a heater wire which pierces the folded-back portion of protective tape 222 to protrude from electrode base 23 like a whisker. In this case, when handle heater 2 is attached to steering-wheel main body 30 and the electricity is turned on, there is a risk that the approaching electrode portions may short-circuit. There is also another risk that a worker may get injured by the heater wire protruding from protective tape 222. Accordingly, there is room for improvement also in safety of work. In this respect, although the aforementioned problem can be solved by performing cutting work so that no heater wire is caused to protrude like a whisker in electrode base 23, such solution is not preferable since the work becomes complicated, for example, due to need to observe the cut surface with a microscope.

An object of the present invention is to provide a handle heater ensuring high safety when the electricity is turned on or when the handle heater is handled at work.

### Solution to Problem

A handle heater according to one aspect of the present invention includes: a mesh heating element including a plurality of heater wires knitted into mesh; and an electrode to be disposed to either end of the mesh heating element. Electrode includes: metal foil to which the mesh heating element is welded; and an insulating protective tape to be folded back along a width direction of the handle heater to sandwich an electrode base on front and back sides of the electrode base, the electrode base including the metal foil and the end of the mesh heating element. The mesh heating element is disposed such that the end of the mesh heating element in a length direction of the handle heater is aligned with an end surface of the metal foil. There is a space between an end of the electrode base in the length direction and a folded-back portion of the insulating protective tape.

### Advantageous Effects of Invention

According to the present invention, even when a heater wire protrudes from an electrode base like a whisker, the heater wire does not protrude outside protective tape and is securely held inside of the protective tape, so that no short circuit arises when the electricity is turned on and no worker would get injured. Therefore, the handle heater ensuring high safety when the electricity is turned on or when the handle heater is handled at work is provided.

### BRIEF DESCRIPTION OF DRAWINGS

FIG. 1 is a plan view illustrating a heater main body of a traditional handle heater;

FIG. 2 is a sectional view illustrating an end (electrode portion) of the traditional heater main body;

FIG. 3 illustrates a steering wheel to which the traditional handle heater is attached;

FIGS. 4A and 4B illustrate a steering wheel to which a handle heater according to one embodiment of the present invention is attached;

FIG. 5 is a plan view illustrating a heater main body of the embodiment of the present invention;

FIG. 6 is a sectional view illustrating an end (electrode portion) of the heater main body;

FIG. 7 is a perspective view illustrating the heater main body;

FIG. 8 illustrates tricot knitting; and

FIG. 9 is a sectional view illustrating a welded state at the electrode of the heater main body.

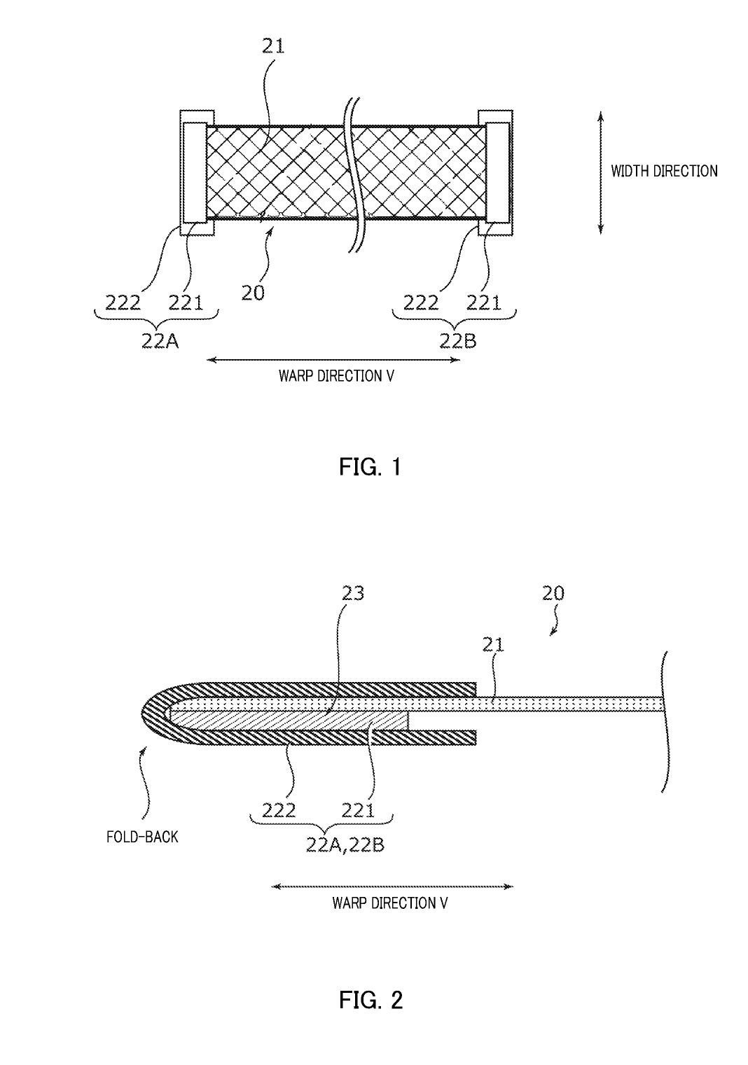

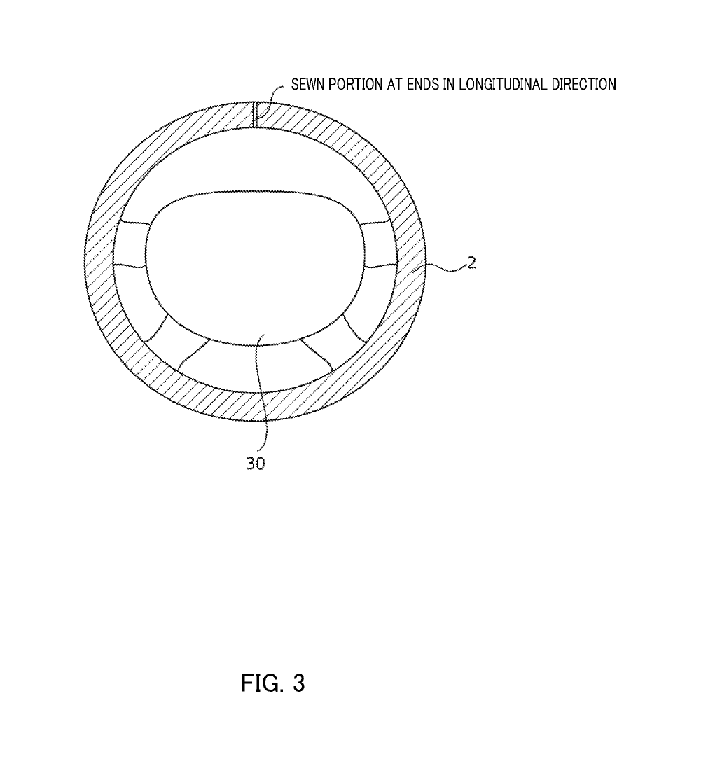

### DESCRIPTION OF EMBODIMENTS

Hereinafter, an embodiment of the present invention will be described in detail with reference to the accompanying drawings.

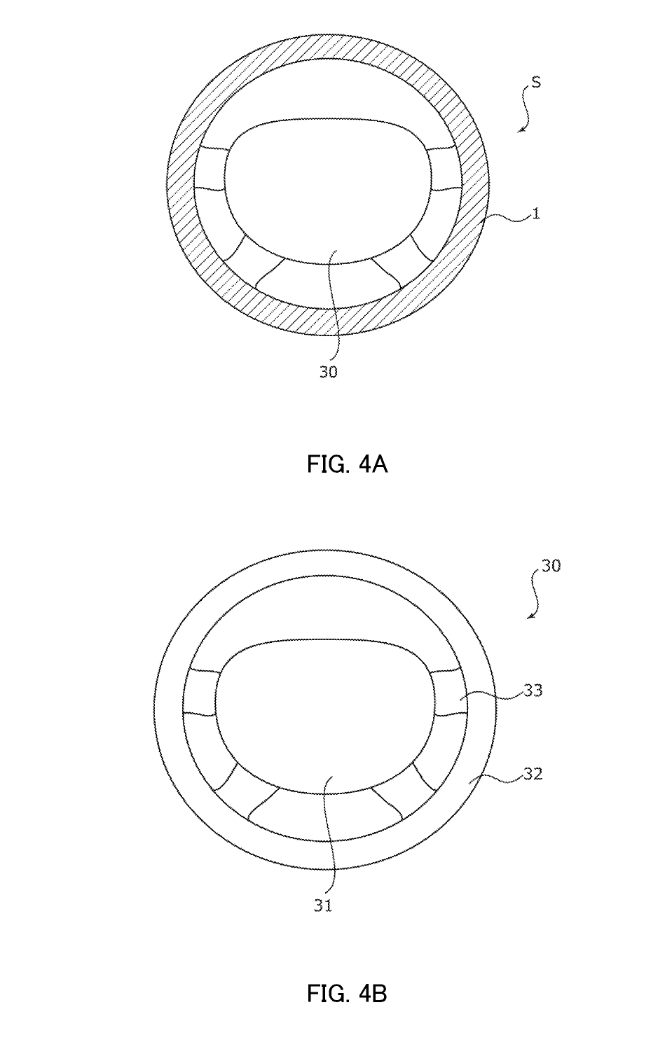

FIGS. 4A and 4B illustrate steering wheel S to which handle heater 1 according to one embodiment of the present invention is attached. FIG. 4A illustrates the state where handle heater 1 is attached, and FIG. 4B illustrates the state before handle heater 1 is attached.

As illustrated in FIG. 4B, steering-wheel main body 30 includes boss portion 31 connected to a steering shaft (not illustrated), annular rim portion 32 to be held during driving, and spoke portion 33 extending from boss portion 31 toward rim portion 32. As illustrated in FIG. 4A, handle heater 1 is disposed to rim portion 32.

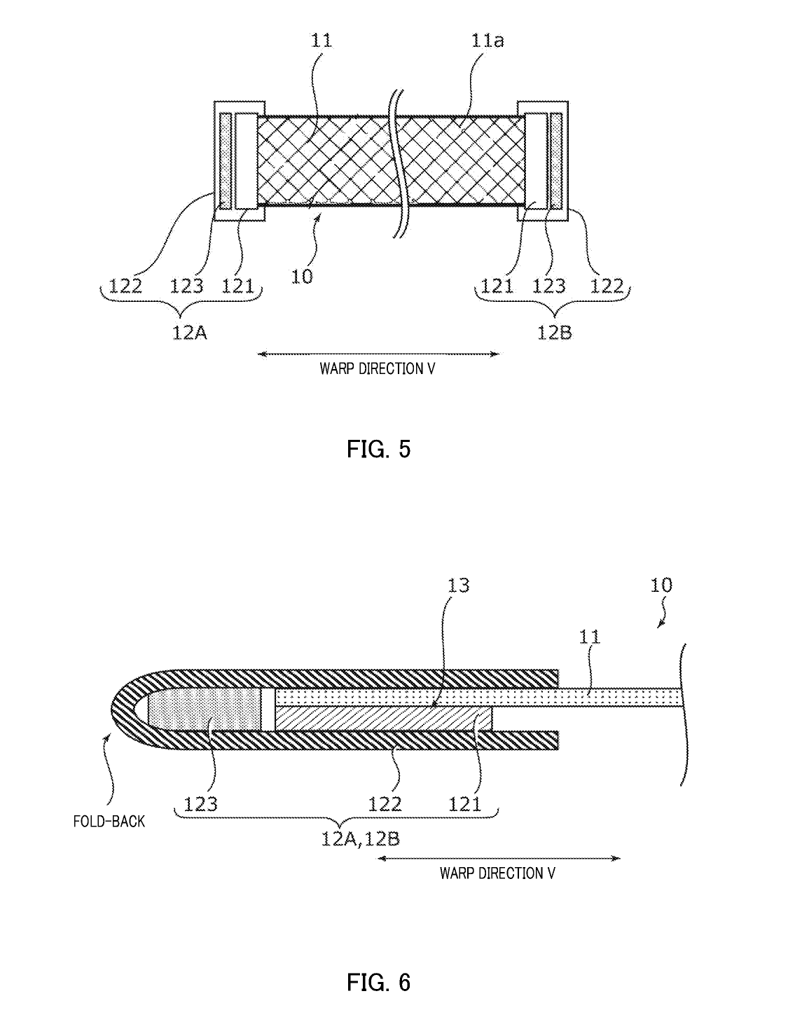

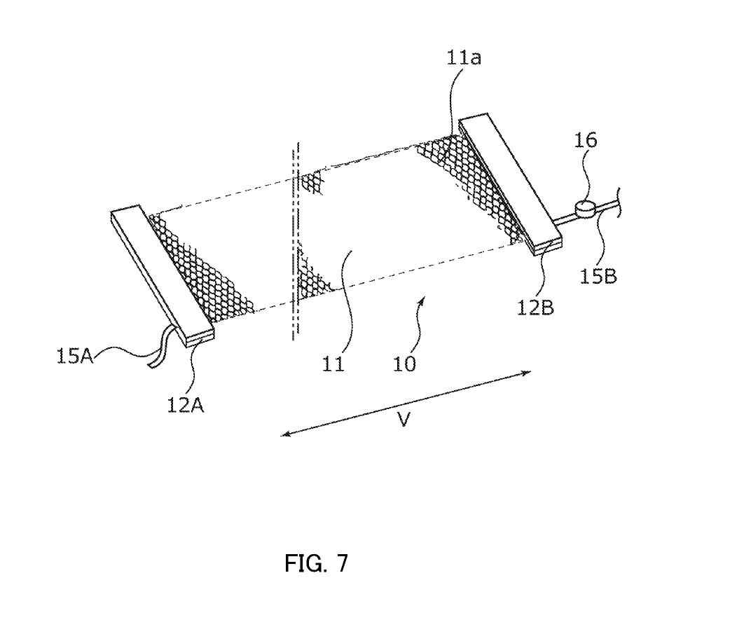

FIGS. 5 to 7 illustrate heater main body 10 built into handle heater 1. FIG. 5 is a plan view illustrating heater main body 10, FIG. 6 is a sectional view illustrating an end (electrode portion) of heater main body 10, and FIG. 7 is a perspective view illustrating heater main body 10. As illustrated in FIGS. 5 to 7, heater main body 10 includes mesh heating element 11 and electrodes 12A and 12B.

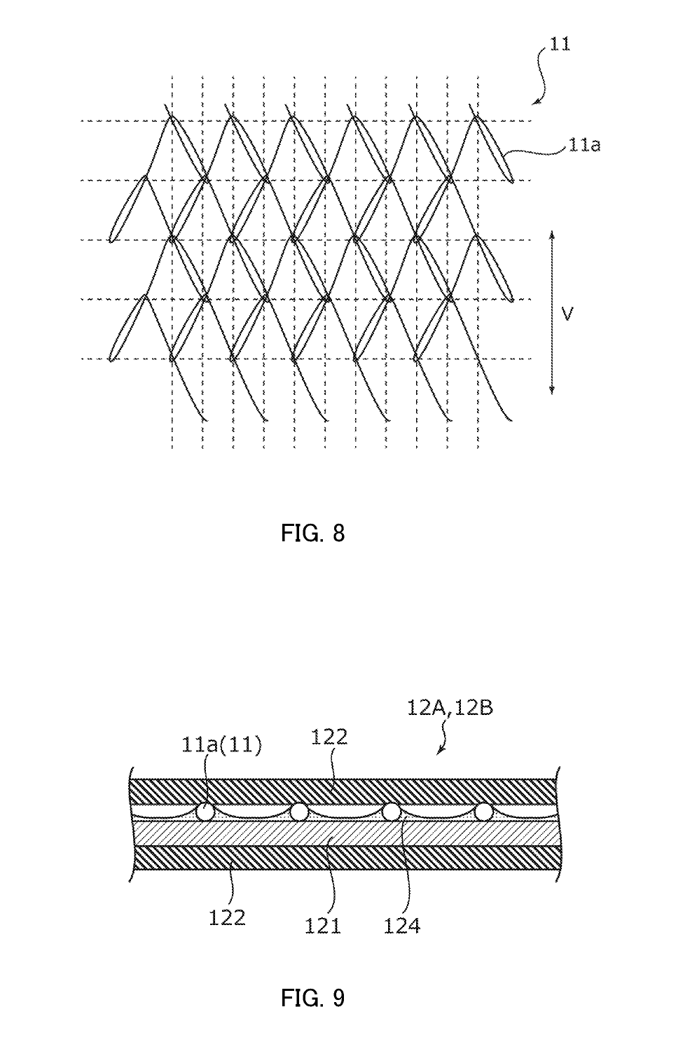

Mesh heating element 11 includes multiple heater wires 11a knitted into mesh and is formed into a belt shape as a whole. Mesh heating element 11 is formed by tricot knitting of multiple heater wires 11a of the same wire diameter, for example (see FIG. 8). Tricot knitting is the way of knitting in which loops are consecutively formed in planar form in warp direction V. A warp knitting machine is usually used for forming mesh heating element 11.

Heater wires 11a are each an enameled wire formed from a metal conductor and an insulating coating formed on the metal conductor. The metal conductor of heater wire 11a is generally formed from a copper wire. However, the metal conductor can also be formed from a copper alloy wire containing 1% or more nickel, corrosion-resistant alloyed wire such as a Nichrome wire, or the like. A conductor material of heater wire 11a is selected depending on a heating value per unit area required for mesh heating element 11.

An insulating paint forming the insulating coating of heater wire 11a is preferably a paint containing polyvinyl acetal, polyurethane, polyamide imide, or polyimide as its main ingredient.

The insulating paint containing polyvinyl acetal or polyurethane as its main ingredient exhibits heat resistance in a range of from 100 to 150 degrees Celsius and, moreover, soldering can be performed without removal of the insulating coating of heater wire 11a. Therefore, at electrodes 12A and 12B, the working time for soldering mesh heating element 11 to metal foil 121 can be shortened, and in addition, solder connection is highly reliable.

Meanwhile, the insulating paint containing polyamide imide or polyimide as its main ingredient exhibits high heat resistance, and is excellent in abrasion resistance. Therefore, such an insulating paint can ensure the insulating property with its extremely-thin uniform coating, so that the outer diameter of heater wire 11a is not made unnecessarily great. For example, when the metal conductor has a wire diameter of 0.07 mm, the minimum coating thickness is to be 0.003 mm in the case of an enameled wire in Class 3 of JIS standard. Moreover, since such an enameled wire can withstand the severe mechanical bending during knitting, tricot knitting becomes easier. Furthermore, a needed heat-resistance grade can be selected from a broad range of grades.

The wire diameter of heater wire 11a is preferably from 0.02 to 0.12 mm, and more preferably from 0.06 to 0.08 mm. This wire diameter allows reconciliation between the intensity and flexibility of heater wire 11a. Therefore, mesh heating element 11 which is highly stretchable and flexible can be formed by interlacing multiple heater wires 11a such that their loops are continuously formed in the warp direction.

Electrodes 12A and 12B are respectively disposed to the both ends of mesh heating element 11 in warp direction V (hereinafter, referred to as “length direction V”). Lead wires 15A and 15B are drawn out from electrodes 12A and 12B. Thermostat 16 is connected to one of lead wires 15B. Lead wires 15A and 15B are connected to power-supply terminals (not illustrated) of the automobile through the inside of spoke portion 33, for example.

Electrodes 12A and 12B each have a structure in which a corresponding one of the both ends of mesh heating element 11 is placed on metal foil 221 and welded thereto such that the end of mesh heating element 11 and metal foil 221 are planar and thin, and the end of mesh heating element 11 and metal foil 121 are sandwiched by insulating protective tape 122. For example, soldering, ultrasonic welding, spot welding, laser welding, or the like is preferable for a method of welding metal foil 121 and mesh heating element 11 together. Metal foil 121 and mesh heating element 11 are welded by soldering in the embodiment of the present invention (see FIG. 9).

Metal foil 121 is rectangular with a predetermined width (length along the length direction of handle heater 1) and length (length along the width direction of handle heater 1). It is preferable that metal foil 121 should have a thickness of from 0.01 to 0.5 mm With this preferable thickness, moderate flexibility is ensured, so that when handle heater 1 is attached to steering-wheel main body 30, electrodes 12A and 12B can be prevented from being broken. Moreover, unnecessary heat generation can be prevented.

Preferably, metal foil 121 is formed performing coating processing such as plating on conductive and corrosion-resistant nonferrous metal, such as tin, solder, gold, or the like. With this metal foil 121, oxidation of the surface of metal foil 121 can be prevented. Note that, metal foil 121 may also be conductive and corrosion-resistant nonferrous metal, such as gold, silver, nickel, or the like.

Solder layer 124 preferably has a thickness of from 5 to 30 μm. Solder in which the flux content is high and is excellent in high-temperature properties and in wettability is preferable. Note that, lead-free solder, for example, based on the tin-silver-copper system, tin-silver-bismuth system, and/or the like is preferable from a viewpoint of environmental protection.

It is preferable that protective tape 122 be subjected to flame-retardant treatment and be formed from a highly elastic and flexible insulating material. For example, a nonwoven fabric made from heat-resistant polyester fibers is applicable as the material of protective tape 122. It is preferable that an adhesive of protective tape 122 be based on silicone, acrylics, thermosetting rubber, or the like from a viewpoint of flame retardance and heat resistance. Specifically, flame-retardant Nomex adhesive tapes, flame-retardant cloth adhesive tapes, polyimide tapes, fluoro-resin tapes, or the like are applicable for protective tape 122. In addition, a waterproof high polymer film may be interposed between protective tape 122 and electrode base 13 including metal foil 121 and mesh heating element 11 soldered to metal foil 121. With this waterproof high polymer film, a highly-waterproof electrode structure can be achieved.

In electrode base 13, after an end of mesh heating element 11 is welded to metal foil 121, mesh heating element 11 is cut such that the end of mesh heating element 11 is aligned with the end surface of metal foil 121. Accordingly, mesh heating element 11 is disposed such that the end of mesh heating element 11 in the length direction is aligned with the end surface of metal foil 121. In this case, there may be heater wire 11a which protrudes like a whisker from an end surface of electrode base 13. When heater wire 11a protruding from the end surface of electrode base 13 pierces protective tape 122 so as to even protrude outside, this heater wire 11a would cause the short circuit when the electricity is turned on and would also cause an injury of a worker.

In the embodiment of the present invention, in order to prevent heater wire 11a from piercing the folded-back portion of protective tape 122 so as to protrude outside, there is a space (whose reference numeral is omitted) provided between the end of electrode base 13 in the length direction and the folded-back portion of protective tape 122, and spacer 123 made, for example, from a nonwoven fabric is disposed in this space. The length of the space may be long enough to house heater wire 11a which would protrude from electrode base 13.

It is preferable, here, that spacer 123 should have a belt shape and be disposed parallel to electrode base 13. Additionally, it is preferable that the length of spacer 123 along the width direction of handle heater 1 be 70% or more of the length of electrode base 13 along the width direction of handle heater 1. The length of spacer 123 only have to be shorter than the outer periphery of rim portion 32 to which handle heater 1 is attached. FIG. 5 illustrates the case where the length of spacer 123 and the length of electrode base 13 as set are the same as each other. With this configuration, it is possible to securely hold heater wire 11a inside of protective tape 122 and to utilize spacer 123 as a mark for positioning electrode base 13 to protective tape 122.

Additionally, when a clearance between spacer 123 and electrode base 13 is greater than 50% of the width of spacer 123, protective tape 122 becomes easier to be bent at this portion of clearance and the risk that heater wire 11a may pierce protective tape 122 is caused when handle heater 1 is handled. Therefore, it is preferable that the clearance between spacer 123 and electrode base 13 be 50% or less of the width of spacer 123.

Moreover, when the width of spacer 123 is less than 30% of the width of electrode base 13, the enough space cannot be secured, and when the width of spacer 123 is greater than 100% of the width of electrode base 13, electrodes 12A and 12B become unnecessarily large. Therefore, it is preferable that the width of the spacer along the length direction of handle heater 1 be from 30% to 100% of the width of electrode base 13 along the length direction of handle heater 1.

Additionally, it is preferable that spacer 123 be formed from an elastic nonwoven fabric and the thickness of spacer 123 before assembly be greater than the thickness of electrode base 13. With such spacer 123, when protective tape 122 is applied to electrode base 13, that spacer 123 and electrode base 13 are securely sandwiched by protective tape 122. Therefore, heater wire 11a cannot advance beyond spacer 123, and is securely held inside of protective tape 122.

Additionally, it is preferable that the length of protective tape 122 along the width direction of handle heater 1 be longer than the length of electrode base 13 along the width direction of handle heater 1. Specifically, it is preferable that the both ends of protective tape 122 protrude 0.5 to 2.0 mm beyond the ends of electrode base 13, respectively. With this configuration, the ends of electrode base 13 in the width direction are also covered by protective tape 122, so that even when heater wire 11a projects from the ends of electrode base 13 in the width direction, it is ensured that this heater wire 11a is held inside of protective tape 122.

As described above, handle heater 1 includes mesh heating element 11 including a plurality of heater wires 11a knitted into mesh, and electrodes 12A and 12B to be disposed to the both ends of mesh heating element 11. Electrodes 12A and 12B each include: metal foil 121 to which mesh heating element 11 is welded; and insulating protective tape 122 adapted to sandwich electrode base 13 on front and back sides of electrode base 13 by being folded back along the width direction, electrode base 13 including metal foil 121 and one of the both ends of mesh heating element 11. Mesh heating element 11 is cut (or disposed) such that the both ends of mesh heating element 11 are aligned respectively with the end surfaces of pieces of metal foil 121, and there is a space between the end of electrode base 13 in the length direction and the folded-back portion of protective tape 122.

With this configuration, even when some of heater wires 11a protrude from electrode base 13 like whiskers, these heater wires 11a do not even protrude outside by piercing protective tape 122 and is securely held inside of protective tape 122, so that no short circuit arises when the electricity is turned on and no worker would get injured. Therefore, handle heater 1 is extremely highly safe when the electricity is turned on or when handle heater 1 is handled at work. Moreover, since it is not necessary to check whether there is any protruding heater wire 11a when mesh heating element 11 is cut along the end surface of metal foil 121, workability is not impaired.

In addition, space formation is ensured by disposing spacer 123 even when a worker forgets to form a space between the end of electrode base 13 in the length direction and the folded-back portion of protective tape 122.

While the invention made by the present inventor has been specifically described based on the preferred embodiment, it is not intended to limit the present invention to the above-mentioned preferred embodiment but the present invention may be further modified within the scope and spirit of the invention defined by the appended claims.

For example, spacer 123 is not necessarily required, and it is enough to form a space capable of housing heater wires 11a which would protrude from electrode base 13.

For example, the shape of spacer 123 is not limited to the belt shape and, for example, spacers 123 may also be interspersed along electrode base 13.

The embodiment disclosed herein is merely an exemplification in every respect and should not be considered as limitative. The scope of the present invention is specified by the claims, not by the above-mentioned description. The scope of the present invention is intended to include all modifications in so far as they are within the scope of the appended claims or the equivalents thereof.

This application is entitled to and claims the benefit of Japanese Patent Application No. 2016-043468 dated Mar. 7, 2016, the disclosure of which including the specification, drawings and abstract is incorporated herein by reference in its entirety.

### REFERENCE SIGNS LIST

1 Handle heater
10 Heater main body
11 Mesh heating element
11a Heater wire
12A, 12B Electrode
13 Electrode base
121 Metal foil
122 Protective tape
123 Spacer

1. A handle heater, comprising:
a mesh heating element including a plurality of heater wires knitted into mesh; and
an electrode to be disposed to either end of the mesh heating element, wherein the electrode includes:
metal foil to which the mesh heating element is welded; and
an insulating protective tape to be folded back along a width direction of the handle heater to sandwich an electrode base on front and back sides of the electrode base, the electrode base including the metal foil and the end of the mesh heating element,
wherein the mesh heating element is disposed such that the end of the mesh heating element in a length direction of the handle heater is aligned with an end surface of the metal foil, and
wherein there is a space between an end of the electrode base in the length direction and a folded-back portion of the insulating protective tape.

2. The handle heater according to claim 1, further comprising a spacer to be disposed in the space.

3. The handle heater according to claim 2, wherein
the spacer has a belt shape and is disposed parallel to the electrode base.

4. The handle heater according to claim 3, wherein
the length of the spacer along the width direction of the handle heater is 70% or more of the length of the electrode base along the width direction of the handle heater.

5. The handle heater according to claim 3, wherein
a clearance between the spacer and the electrode base is 50% or less of the width of the spacer.

6. The handle heater according to claim 5, wherein
the width of the spacer along the length direction of the handle heater is 30% to 100% of the width of the electrode base along the length direction of the handle heater.

7. The handle heater according to claim 2, wherein:
the spacer is formed from a nonwoven fabric, and
the thickness of the spacer before assembly of the handle heater is greater than the thickness of the electrode base.

8. The handle heater according to claim 1, wherein:
the length of the insulating protective tape along the width direction of the handle heater is greater than the length of the electrode base along the width direction of the handle heater, and
the insulating protective tape covers ends of the electrode base in the width direction.
